(19) United States
(12) Patent Application Publication
(10) Pub. No.: US 2019/0025259 A1
(43) Pub. Date: Jan. 24, 2019

(54) FREEZE DETECTOR FOR A PIPE OF A CONTAINER

(71) Applicant: Roderinno AB, Nacka Strand (SE)

(72) Inventor: Fredrik MAGNUSSON, Saltsjö-Boo (SE)

(21) Appl. No.: 16/069,290

(22) PCT Filed: Jan. 13, 2017
(86) PCT No.: PCT/SE2017/050032

§ 371 Date: Jul. 11, 2018

(30) Foreign Application Priority Data
Jan. 13, 2016 (SE) 1650031-6

(51) Int. Cl. G01N 29/14; G01N 29/44; G08B 19/02

(52) U.S. Cl. CPC G01N 29/14; G01N 2291/0251; G08B 19/02; G01N 29/4427

(57) ABSTRACT

The present invention relates to a freeze detector (10) for a pipe or container (20) being adapted for holding and transporting water or water containing liquids, said freeze detector (1) comprising a microphone housing (13), comprising a microphone (11), adapted to be mounted on an outside surface (22) of said pipe or container (20), and adapted to receive sound from within said pipe or container (20), said sound forming an acoustic pattern, an attachment member (15) for attaching said microphone (11) to said pipe, and an processing unit(16) adapted to receive, process and analyze the acoustic pattern of the sound transmitted by the microphone and to be activated when at least one predetermined threshold value (T_{freeze}) is detected in the acoustic pattern received by said microphone (11), wherein said threshold value (T_{freeze}) indicates local freezing of said water or water containing liquids inside said pipe or container (20).

### FIELD OF THE INVENTION

The present invention relates to a freeze detector and in particular to a freeze detector for pipes or containers, according to the preamble of the independent claim.

### BACKGROUND OF THE INVENTION

Frozen water pipes are a common problem in cold climates and a frequent cause of water damage to buildings and their contents, roads and other structures. To prevent pipes from breaking, bursting or cracking due to the large expansion of water volume when transitioning from liquid to ice, many different solutions have been used. One simple method is to ensure that the water in the pipe is constantly moving, e.g. by leaving a faucet slightly open. However, this method wastes water, and is not effective in very cold environments. Another way to prevent damage is to empty the pipes before the cold season. Obviously, the pipes can then not be used until warmer temperatures return.

Exposed pipes are often insulated or otherwise protected from exposure to freezing temperatures. However, any breach of an insulating layer, such that e.g. cold air can seep through the insulation, can quickly freeze the pipes. Different heating systems can be used to ensure that the pipes are kept at a temperature above freezing. The pipes themselves can be constructed to be expandable such that the pipe can expand without breaking when the water freezes. However, all the above examples delay or reduce the risk of freezing or freezing damage, and even when using them, if a breach occurs, the pipe can still freeze locally, and thus risk rupture of a pipe, causing leakage.

The inventor of the present invention has identified a need for a way to detect imminent freezing inside a pipe, such that measures can be taken to prevent freezing before it occurs.

### SUMMARY OF THE INVENTION

An object of the present disclosure is to provide a freeze detector for a water pipe or container which is capable of detecting imminent freezing inside the pipe or container.

A further object of the present invention is to provide such a freeze detector which can further alert users to imminent freezing inside the pipe or container.

The above-mentioned objects are achieved by the present invention according to the independent claim. Preferred embodiments are set forth in the dependent claims.

In accordance with the present disclosure there is provided a freeze detector for a pipe or container being adapted for holding and transporting water or water containing liquid comprises a housing comprising a contact microphone, or a contact microphone without a housing, adapted to be mounted on an outside surface of a pipe or container. The contact microphone is adapted to receive sound from within the pipe, where the sound forms an acoustic pattern, typically of higher density, between the sounds, indicating imminent freezing of the water, or the water containing liquid inside the pipe or container. Test have indicated that this pattern is not always clear when listening on a long distance. In that case the characteristics of the freezing sound (wave form) is processed by a processing unit to determine and/or analyze if the water is freezing inside the pipe or container.

The freeze detector further comprises an attachment member for attaching the microphone to the pipe, and a processor unit adapted to be activated, typically adapted to send an alarm) when at least one predetermined threshold value of an acoustic pattern indicating freezing water, is detected in the acoustic pattern received by the contact microphone and transmitted to the processor unit for processing typically including detection and/or analysis. The processing unit is adapted to receive, process and analyze the acoustic pattern of the sound transmitted by the microphone. According to our best knowledge, it is the stress providing energy when the ice is crystallized that can be detected.

In accordance with the present disclosure, there is also provided a freeze detector assembly for monitoring pipes or containers being adapted for holding and transporting water or water containing liquids. The assembly comprises at least two microphones each adapted to be mounted on an outside surface of a pipe, and each microphone adapted to receive sound from within the pipe, said sound forming an acoustic pattern. Each microphone is provided with an attachment member for attaching the microphone to the pipe, and at least one processing unit adapted to receive, process and analyze the acoustic pattern of the sound transmitted by the microphone and to be activated (such as activating an alarm) when at least one predetermined threshold value is detected in an acoustic pattern received by one of said microphones and transmitted to the processing unit.

The processing unit determines if an alarm should be activated or not. The microphones can be directly coupled or remotely coupled to the processing unit. The processing unit can be arranged in different positions to the microphone, adjacent or remote to the microphone, inside or outside a housing of the microphone.

The microphone 11 is an acoustic microphone adapted to receive sound, typically a contact microphone adapted to receive vibrations from the pipe 20, where the sound forms an acoustic pattern.

Herein, this disclosure, an acoustic pattern indicating freezing water is referred to as such a pattern recorded from freezing water in a similar pipe.

Embodiments of the disclosure will now follow, with reference to appended drawings.

### SHORT DESCRIPTION OF THE APPENDED DRAWINGS

FIG. 1 shows a perspective view of a freeze detector for a pipe according to an embodiment of the disclosure.

FIG. 2 shows a cross-sectional view of the freeze detector, shown in FIG. 1, for a pipe in a plane L-L oriented along a longitudinal axis of the pipe.

FIG. 3 shows a cross-sectional view of a freeze detector, according to an embodiment of the disclosure, for a pipe in a plane perpendicular to a longitudinal axis of the pipe.

FIG. 4 shows a cross-sectional view of another freeze detector, according to an embodiment of the disclosure, for a pipe in a plane perpendicular to a longitudinal axis of the pipe.

FIG. 5 shows a cross-sectional view of yet another freeze detector, according to an embodiment of the disclosure, for a pipe in a plane oriented along a longitudinal axis of the pipe.

FIG. 6 shows an acoustic pattern indicating freezing water according to an example.

### DETAILED DESCRIPTION

Before a detailed description of embodiments of the disclosure is given, a background of known facts is given for a better understanding.

When water freezes, i.e. changes from liquid to solid form, its volume increases by about 9% under atmospheric pressure. This is in contrast to many other liquids, and is due to the low packing efficiency of the water molecules in the structure of ice. Such expansion inside e.g. a water pipe causes strain on the pipe and possible breakage, resulting in leakage from the pipe. Water pipes are often located away from sight, such as underground, within walls of buildings etc. Therefore, even small leaks, when not detected immediately, may result in a large volume of escaped water from the pipe, which can cause extensive damage to property.

In addition, when water freezes, an acoustic pattern indicating freezing water can be recorded by the microphone in a passive way. Typically, no personnel such as an operator, is required to actively control the microphone and performing any task for checking freezing since this is provided automatically.

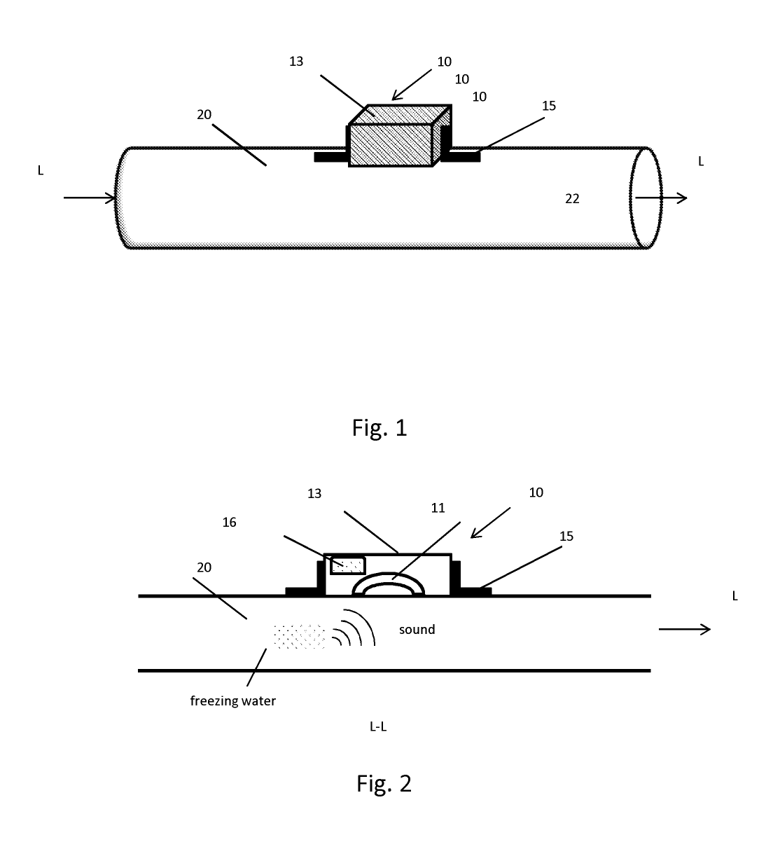

Now is referred to FIG. 1.

FIG. 1 shows a perspective view of a freeze detector 10, according to an embodiment of the disclosure, for a pipe 20 being adapted for holding and transporting water or water-containing liquid comprising a microphone 11 adapted to be mounted on an outside surface 22 of a pipe 20. Preferably, the microphone 11 is provided within a housing 13. FIG. 2 shows a cross-sectional view of the freeze detector 11, shown in FIG. 1, for a pipe 20 in a plane L-L oriented along a longitudinal axis L of the pipe 20. In the figures, the microphone 11 and in particular it's outer housing 13 is illustrated as a box shape. However, the housing 13 may be of any suitable shape, such as flat, rounded, semi-spherical etc. Preferably, the shape is adapted to fit the outer shape of the pipe 20 and also to the surrounding environment.

The microphone 11 is an acoustic microphone adapted to receive sound, typically a contact microphone adapted to receive vibrations from the pipe 20, where the sound forms an acoustic pattern. The microphone 11 is oriented such that it receives sound, typically vibrations, mainly from the interior 24 of the pipe 20. In various embodiments of the disclosure, the microphone 11 is a conventional contact microphone detecting vibrations.

One example is a piezo-element, but also other types of acoustic (vibration) detectors are possible. Common to all sensors are that they are adapted to be in direct contact with an outside of the pipe or container and record vibrations in the pipe or container instead of in any other surrounding media such as air or water.

The different types of microphones are applicable to embodiments described in this disclosure even if only the generic term “microphone” is used.

In a freeze detector 10, the microphone 11 may be adapted to receive sound, typically vibrations, from the pipe 20 continually (i.e. at regular intervals) or continuously over time T, and the acoustic pattern is based on detected sound (vibrations) over time. This is described in more detail with reference to FIG. 6, which shows an acoustic pattern indicating freezing water according to an example.

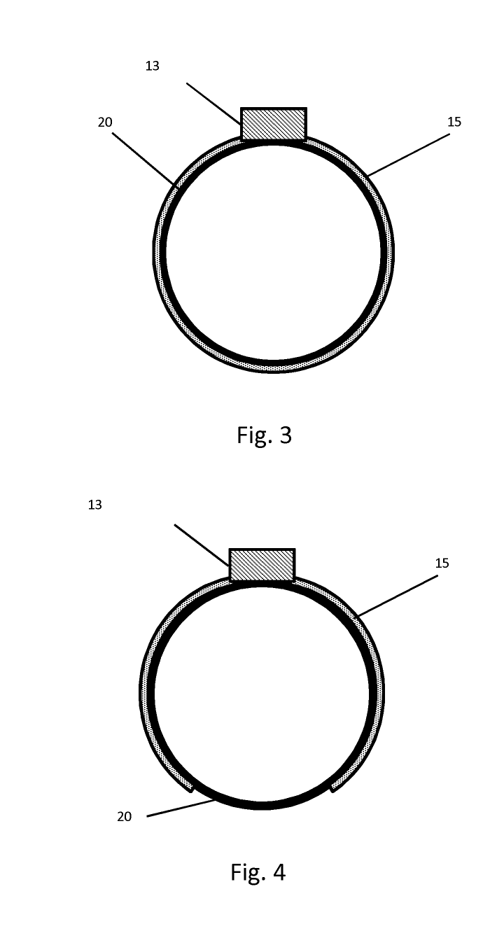

According to various embodiments, the freeze detector 10 further comprises an attachment member 15 for attaching the microphone 11, or typically the housing 13, to the pipe 20. In FIGS. 1 and 2 the attachment member 15 is illustrated as a set of brackets that can be attached to the pipe 20 for holding the microphone 11 and its housing 13 against the outer surface of the pipe 20. However, many other examples of attachment members 15 are conceivable, such as one or more magnets, screws, snaps, bolts, straps, bands or clips, etc. The attachment member 15 may comprise or consist of glue, adhesive, Velcro etc. One example is shown in FIG. 3, showing a strap or band arranged around the pipe 20 to hold the microphone housing 13 in place. This band can be made of e.g. metal, fabric, plastic or any other material or combination thereof known in the art. The band can be provided with a buckle or clasp for fastening and unfastening of the band around the pipe. Another example of an attachment member is shown in FIG. 4, wherein the microphone housing 13 is mounted on a clip adapted to snap onto a pipe. Such a clip may comprise two or more semi-rigid extensions adapted to a general outer shape (outside 22) of a pipe 20, such that the clip can be attached by snapping onto a pipe, and easily removed by pulling away from the pipe 20.

According to an alternative embodiment, the freeze detector can be provided on a container for holding liquids. This embodiment is not illustrated and described in more detail, since it is obvious for the skilled person to understand based on the above disclosure related to pipes.

The freeze detector 10 further comprises an processing unit 16 adapted to be activated (activating an alarm) when at least one predetermined threshold value indicating freezing water is detected in the acoustic pattern received by the microphone 11. The processing unit 16 and the microphone 11 can be coupled to each other and arranged to communicate with each other in a conventional way per se. The processing unit 16 is adapted to receive, process and analyze the acoustic pattern of the sound transmitted by the microphone.

Now is referred to FIG. 6 showing an acoustic pattern indicating freezing water according to an example.

A predetermined threshold value T_{freeze} is chosen such that the value indicates imminent local freezing of the water or water-containing liquids inside the pipe or container. One or more such threshold values T_{freeze} can be used in the freeze detector as disclosed. Further, threshold values T_{freeze} may also or as an alternative be chosen to indicate actual freezing, i.e. the formation of ice, of the water or water-containing liquids inside the pipe.

Preferably, a processing unit 16 is provided in communication with the freeze detector 10 for processing the acoustic pattern received by the microphone 11 and identification of one or more threshold values. Such threshold values trigger the activation of the processing unit 16 activating an alarm and/or other actions (see below). The processing unit 16 may physically be provided inside the common housing 13 with the microphone 11 and/or provided as a separate part of the freeze detector 10. In this way, alarm about freezing can be obtained before actual freezing which saves pipes from freezing rendering damages, provided the alarm triggers some kind of heating or any other suitable measure to be taken. This is a great advantage compared to prior art devices, which typically indicate first when the water is actually frozen and damages thereby are unavoidable.

It is obvious for the skilled person to obtain suitable threshold values using routine experiments without departing from the inventive concept of listening to freezing water by means of a contact microphone provided on the pipe. It is obvious for the skilled person that different pipes, different materials and distances influence the sound of freezing water received by the contact microphone. Therefore, this is not described in more detail in this disclosure.

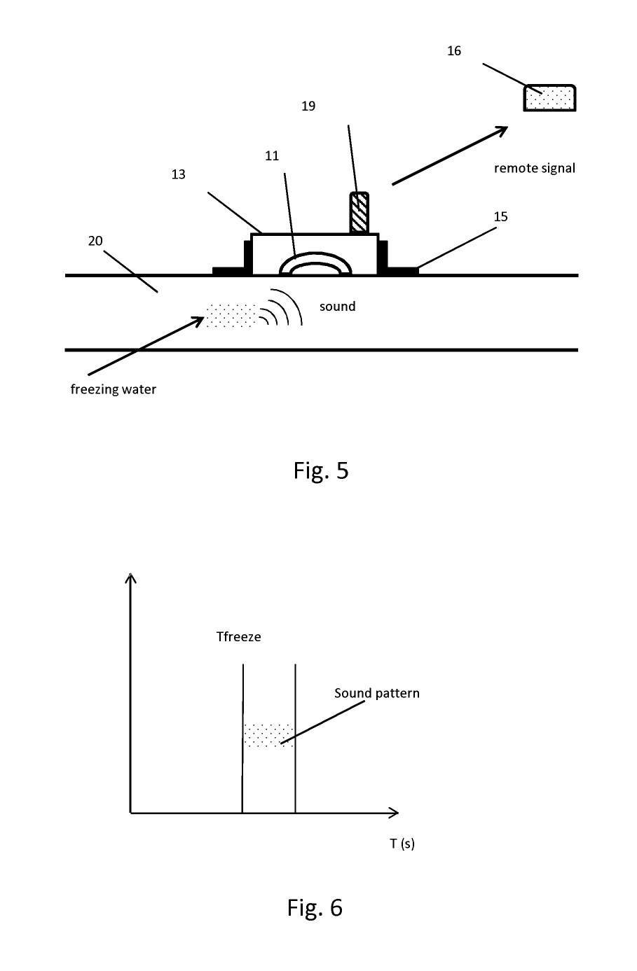

The freeze detector 10 may also be provided wherein the processing unit 16 is arranged remotely from the microphone 11, as schematically illustrated in FIG. 5. Such a freeze detector 10 further comprises a transceiver 19 connected to the microphone 11 for relaying detected sound from the microphone 11 to the processing unit 16. The transfer of a signal “sound” comprising detected sound from the microphone may be provide in any number of ways, such as a wired signal, a radio signal, Bluetooth, or any other type of wireless signal, which is indicated schematically with the expression “signal” in FIG. 5.

When the processing unit 16, either provided locally (as shown in FIG. 2) at the site of the mounted microphone 11, or provided remotely (as shown in FIG. 5) from the microphone 11 and adapted to receive a remote signal from a transceiver 19, is communicating with the microphone 11, a number of actions may be initiated, either separately or in combination.

The processing unit 16 may sound an audio and/or visual signal. In addition, or as an alternative, a heating system (not shown) for heating the pipe and the water inside may be activated when the alarm is triggered. As non-limiting examples, such a heating system may comprise a heating wire, a system adapted to infuse the pipe with warm water or a system adapted to heat the pipe itself.

The freeze detector may also be provided as an assembly (not shown) comprising at least two microphones as described above, wherein each microphone may be provided with an attachment member according to any example above. These microphones may preferably be arranged at different locations on the same or different pipes, and can be any number of separate microphone units. Further, the two or more microphone units are connected to at least one common processing unit through a wired or wireless connection as described above. The processing unit may be provided in a location where it can be monitored for activation by a user. As an alternative, the freeze detector assembly is fully automatic, and only needs to be accessed by a user for installation, service and/or adjustment.

In a freeze detector assembly with two or more microphones connected to a common alarm system, the alarm system may be adapted in a similar way as described above, i.e. adapted to be activated when at least one predetermined threshold value is detected in an acoustic pattern received by one of the microphones. Further, such an assembly may also comprise a transceiver connected to each microphone for relaying detected sound from the microphone to the processing unit, as described above.

In any of the above described freeze detectors, each microphone may be provided with an unique identification that can be transmitted, or alternatively a positional detector, such as a GPS unit or other positional indicator and a transceiver. In such freeze detectors, each transceiver is adapted to send, in addition to a signal triggering the alarm member, also positional information to the alarm member, the positional information being that indicating the location of the microphone, and thereby an imminent freezing situation.

The present invention is not limited to the above-described preferred embodiments. Various alternatives, modifications and equivalents may be used. Therefore, the above embodiments should not be taken as limiting the scope of the invention, which is defined by the appending claims.

1. A freeze detector for a pipe or container being adapted for holding and transporting water or water containing liquids, which freeze detector is capable of detecting imminent freezing inside the pipe or container, said freeze detector comprising
a microphone housing, comprising a microphone, adapted to be mounted on an outside surface of said pipe or container, and adapted to receive sound from within said pipe, said sound forming an acoustic pattern indicating imminent freezing water,
an attachment member for attaching said microphone to said pipe, and
an processing unit adapted to receive, process and analyze the acoustic pattern of the sound transmitted by the microphone and to be activated when at least one predetermined threshold value (T_{freeze}) is detected in the acoustic pattern received by said microphone, wherein said threshold value T_{freeze} indicates imminent local freezing of said water or water containing liquids inside said pipe or container.

2. The freeze detector according to claim 1, wherein said microphone is a contact microphone adapted to receive sound from within said pipe or container continually or continuously over time, and said acoustic pattern is based on detected sound over time.

3. The freeze detector according to claim 1, further comprising a control unit, said control unit being adapted for processing said acoustic pattern received by the microphone and identifying one or more predetermined threshold values.

4. The freeze detector according to claim 1, wherein said processing unit is arranged remotely from said microphone and the freeze detector further comprises a transceiver connected to the microphone for relaying detected sound from said microphone to said processing unit.

5. The freeze detector according to claim 4, wherein said transceiver is a radio transceiver or a wireless transceiver.

6. The freeze detector according to claim 1, wherein said processing unit emits an audio signal when activated.

7. The freeze detector according to claim 1, wherein said processing unit produces a visual signal when activated.

8. The freeze detector according to claim 1, wherein said attachment member is an attachable and detachable attachment member.

9. The freeze detector according to claim 1, wherein said attachment member is a clip or snap for attachment around at least part of the outer circumference of said pipe.

10. A freeze detector assembly for monitoring pipes or containers being adapted for holding and transporting water or water containing liquids, which freeze detector assembly is capable of detecting imminent freezing inside the pipe or container, said assembly comprising
at least two microphones each adapted to be mounted on an outside surface of a pipe or container, and each microphone adapted to receive sound from within said pipe or container, said sound forming an acoustic pattern indicating imminent freezing of said water containing liquids inside the pipe or container,
each microphone being provided with an attachment member for attaching said microphone to said pipe, and
at least one processing unit adapted to receive, process and analyze the acoustic pattern of the sound transmitted by the microphone and to be activated when at least one predetermined threshold value is detected in an acoustic pattern received by one of said microphones, wherein said threshold value indicates imminent local freezing of said water or water containing liquids inside said pipe or container.

11. The freeze detector assembly according to claim 10, wherein said processing unit is arranged remotely from said at least two microphones and the freeze detector assembly further comprises a transceiver connected to each microphone for relaying detected sound from said microphone to said processing unit.

12. The freeze detector assembly according to claim 11, wherein each microphone is provided with a positional detector, and said transceiver is adapted to send positional information to said processing unit.
